(19) United States
(12) Patent Application Publication
(10) Pub. No.: US 2016/0061950 A1
(43) Pub. Date: Mar. 3, 2016

(54) Synthetic Aperture Imaging Methods And Systems

(71) Applicants: Yuan XU, Toronto (CA); Michael C. KOLIOS, Ancaster (CA); Ping GONG, Toronto (CA); Ying LI, Etobicoke (CA)

(72) Inventors: Yuan XU, Toronto (CA); Michael C. KOLIOS, Ancaster (CA); Ping GONG, Toronto (CA); Ying LI, Etobicoke (CA)

(21) Appl. No.: 14/841,118

(22) Filed: Aug. 31, 2015

Related U.S. Application Data
(60) Provisional application No. 62/044,410, filed on Sep. 1, 2014.

(51) Int. Cl. G01S 13/90

(52) U.S. Cl. CPC G01S 13/90

(57) ABSTRACT

The invention generally relates to the field of synthetic aperture imaging. In particular, the invention relates to systems and methods for generating synthetic transmit aperture (“STA”) signals and processing synthetic aperture imaging (“SAI”) signals for improved signal-to-noise ratio (“SNR”) and spatial resolution. This generally relates to a method to improve the signal-noise-ratio (SNR) of array signals by both encoding the transmission from multiple array elements with waveform modifications and time delays and encoding the receivers into output channels and decoding the measured signals at the selected output channels to estimate the equivalent received signals of a receiver as if only one transmitting element were fired individually in each transmission event. SAI techniques are subsequently applied to the equivalent SAI signals to obtain improved images.

### FIELD OF INVENTION

The invention relates generally to the field of synthetic aperture imaging. In particular, the invention relates to systems and methods for generating synthetic transmit aperture (“STA”) signals and processing synthetic aperture imaging (“SAI”) signals for a lower system cost and an improved performance such as better signal-to-noise ratio (“SNR”) of the radiofrequency signals.

### BACKGROUND OF INVENTION

Synthetic aperture imaging is an imaging technique that has been widely used in different fields such as radar and sonar system, non-destructive testing (NDT) area, seismic survey system, and medical ultrasound imaging. SAI generally tends to provide images with higher resolution than traditional, direct imaging techniques.

SAI generally utilizes synthetic transmit aperture (“STA”). In STA, an array of transmitters and receivers are used. Each element of the transmitter array transmits consecutively. According to this arrangement, the active element, namely transmitting element, emits a semi-spherical wave to cover a large image region and then all the receiver elements are used to acquire data signals from the reflected wave. We call data signals acquired from all elements of the receiver array “traditional STA data”. Traditional STA data acquired in each transmission can be used to reconstruct an image, often low resolution. Multiple low resolution images are obtained after signals from all consecutive transmissions are processed to reconstruct such images. These low resolution images may be combined to form a high-resolution image.

However, often only one or a small number of transmitting elements are selected for each transmission in traditional STA, resulting in relatively low transmission power. For medical imaging devices, low SNR of a STA system is a major problem compared with the conventional B-mode ultrasound imaging method. There have been different proposals to overcome this difficulty of low SNR in STA. For example, in one approach, a Hadamard spatial coding matrix is used to first spatially encode the transmission scheme for multiple transmitters that transmit at the same time and then the inverse of the Hadamard spatial coding matrix is used to decode the received data. However, this generally requires that the various elements of the array probe are driven by different pulse sequences in one transmission, i.e., each individual element would be required to be controlled separately according to the encoding matrix. This therefore may be costly to implement commercially in an ultrasound medical imaging device. According to another similar proposal, some of the transmitting elements transmit a positive pulse while the remaining ones in the transmitter array transmit a phase inverted negative pulse. However, in practice, errors would be introduced into the phase inversion process and these negative pulses may not be exactly the negative version of the positive pulses. The mismatch in pulse shape between the positive pulse and the phase inverted negative pulse tends to degrade performance.

There are other challenges, too. For example, in forming an image or a frame of image in a video recording, the image is generally formed from echo wave signals from multiple channels or transmitting elements. It may be desirable to reduce the number of transmissions per frame for video imaging. Less transmission per frame can increase the imaging frame rate, which makes the data acquisition more robust to image motion, such as patient motion artifacts, and tends to provide better in vivo imaging. Further, the electronics associated with each receiving channel is generally a significant part of the system cost. When the number of receiving channels is large, such as in the planar array for 3D ultrasound imaging, the total cost of the system can be prohibitively expensive. It is therefore desirable to reduce the number of receiving channels while maintain acceptable image quality and imaging frame rate. Yet, less receiving channels or reducing the transmission number per frame generally means less measurement data, which might result in lower SNR in images and compromised image quality.

The forgoing creates challenges and constraints for processing SAI image signals and generating high resolution and high SNR images based on STA and SAI techniques. There is therefore a need for an improved system and method for generating STA signals and processing image signals with both the transmission number per frame and the number of the channels of receiving electronics as small as possible to obtain SAI data for reasonable signal-to-noise ratio (“SNR”) and spatial resolution as compared to the existing art. It is an object of the present invention to mitigate or obviate at least one of the above mentioned disadvantages.

### SUMMARY OF INVENTION

The present invention is directed to systems and methods for generating synthetic transmit aperture (“STA”) signals and processing synthetic aperture imaging (“SAI”) signals for improved signal-to-noise ratio (“SNR”) in the pre-beamforming signals. In general, there are multiple transmission events, each of which yields an image data, and all image data from all transmission events are combined to form an SAI image. Both the transmission patterns and receiver channels selected to receive echo signals can be independently selected and can be varied at the same time from one transmission to another. The transmission patterns, for example, in the form of a transmission vector T, and a receiving encoding matrix R, are stored in a memory storage device of a central control processor, which can provide both the transmission pattern to a transmission multiplexer, MUX_T, and the receiver indices to a receiver signal combiner and selector, MUX_R, before each transmission. In one embodiment, in each transmission event, I elements in an array of transmitting elements transmit pulse signals. A prescribed transmission pattern is applied to the I transmitting elements, such that each of the I transmitting elements is assigned a time delay, or a waveform modification factor, such as weight factor c_li, or both, which may be different from transmitter to transmitter, according to a transmission scheme of the transmission event. In each transmission, a receiver signal combiner and selector MUX_R (controlled by a central control processor) between the receivers and the receiving electronics (e.g., TGC and ADC), combines all the K available receiving elements to form K₁ output channels and then select K₀ of them to connect to the K₀ receiving electronics for data acquisition. After L transmission events, each event having its own transmission scheme and selected receiving channels, data signals received and measured at K₀ output channels of an array of receivers from backscattered waves are converted and decoded to estimate the equivalent measurement data signals at each of the receivers as if only one of the multiple transmitting elements were fired individually in each of the transmission event and the measurements were performed at all the available receiving elements, thus to estimate the equivalent traditional SAI image data. Images with improved resolution and SNR can be reconstructed from such equivalent traditional SAI image data by applying any known SAI techniques.

In one embodiment, four adjacent elements in the receiver array can be combined together as one receiver in the receiving mode. For example, the first bundle includes the first four elements. The next bundle includes the next four elements, that is, the fifth element to the eighth element, and so on. Four sets of transmission and receiving encoding protocols are used to obtain one frame of image. This will reduce the receiving channel number to K/4.

According to another embodiment, both transmission and receiving arrays are encoded with Hadamard matrix for reducing the total number of output channels connected to the receiving electronic unit. One implementation is for the l-th transmission of the total L transmissions, the transmission encoding matrix T₁ is just one selected row of the Hadamard matrix, and the receiver encoding matrix R₁ can be some or all columns of a K-th order Hadamard matrix. The columns can be chosen randomly, or further optimized for a specific imaging application.

According to one method of selecting output channels, all available output channels are divided into two groups, such as channels from 1 to L/2 and channels from L/2+1 to L. In the first transmission event, an output channel, for example, channel #1, is selected from the first group and all channels from the second group are selected. In the second transmission event, an output channel, such as channel #2, from the first group is added to the selected group when another output channel, such as channel #L/2+1, from the second group is removed from the selection. This adding and removing process is repeated until all channels from the first group are selected and all channels from the second group are removed from the selected output channels. According to this method, the total number of output channels selected is about half of the total available channels, thus reducing the number of required electronic elements by half.

As another special case, one class of receiver signal combiner and selectors MUX_R simply pass signals from all receivers to output channels, i.e., the receiver signal combiner and selectors MUX_R do not combine signals at receivers. The receiver signal combiner and selectors MUX_R simply select all or portion of the output channels, in this case, the K₀ receivers, and connect them to the K₀ receiving electronics for data acquisition.

In a delay-encoded synthetic aperture imaging (“DE-SAI”) process, K₀=K, i.e., all the available receivers are selected for receiving signals for each transmission. In the special case of L=I, a special delay-encoded transmission matrix H (a special form square matrix) is used to define the transmission schemes. Selected transmitting elements in each transmission events have a half-period delay. To process the backscattered signals received at and measured by K receivers, a transform in the temporal domain is applied to the measured time-series signals. The result of this transform is decoded, according to a decoding transformation that is determined by the delay encoding pattern, to yield decoded data signals, in a parameter domain, that can be used to produce the traditional SAI time series data through a corresponding inverse transform. The transform used here meets the requirement that the transform of the time delay of a function (or a segment of signal) can be represented as a product of the transform of the function itself and another function that includes the time delay as its variable.

In another embodiment, K₀=K, L=I, i.e., all the available receivers are used for each transmission and the number of total transmissions equals the number of total transmitters. In this embodiment, a special transmission matrix H with weighting factor c_li is used to define the transmission schemes. Selected transmitting elements in each transmission events have a weight defined by c_li, which may be a constant, or more generally a suitably defined function. To process the backscattered signals received at and measured by K receivers, the measured signal is decoded, according to a decoding matrix (for example the inverse of the encoding matrix) in the time domain to yield decoded data signals. The decoded data signals are used to produce the traditional SAI time series data.

Of course, K₀ and K, or L and I, do not have to be equal. For example, in yet another embodiment, it is possible to have K₀<K or L≠I, or both. Pseudo-inversion and other regularization techniques, or other techniques such as compressive sensing, are used to decode the data signals to estimate the equivalent measurement data signals at each of the receivers as if only one of the multiple transmitting elements were fired individually in each of the transmission event and the measurements were performed at all the available receiving elements.

In one aspect of the invention, there is provided a system for generating and acquiring image data signals and processing acquired data signals for reconstructing image data. The system includes a plurality of transmitting elements for emitting image detection pulse waves; a plurality of receiving elements; a central control processor, the central control processor controlling transmission process according to a transmission scheme and controlling receiving process according to a receiving scheme, the transmission scheme specifying transmitters of the plurality of transmitting elements that transmit during a transmission event and a waveform modification and a time delay assigned to each of the transmitting elements specified in the transmission scheme, the receiver scheme specifying how the output channels will be formed by combining the receiving elements and the indices of the output channels to be connected to a plurality of receiving electronics units; a transmitter multiplexer for connecting transmitting elements specified in the transmission scheme with a signal source, a receiver signal combiner and selector for connecting receivers to the receiving electronics units according to the receiver scheme; a signal decoder, said signal decoder being coupled to the receiving electronics units and converting the measured detection signals to equivalent data as if only one transmitter transmits in each transmission event.

In another aspect of the invention, there is provided a system for generating time-delay encoded STA signals and processing received SAI signals. The system includes a plurality of transmitting elements for emitting image detection pulse waves; a plurality of receiving elements; a controller that controls waveform and time delay assigned to each one of the plurality of transmitting elements according to a transmission scheme, a first converter for converting time series data measured at each one of the plurality of receiving elements, which applies a transform to the time series data to convert the time series data to measured detection signals in a parameter domain, a decoder that converts the measured detection signals in the parameter domain to decoded detection signals in the parameter domain by applying a decoding transformation to the measured detection signals, the decoding transformation being derived from the transmission schemes; and a second converter for converting the decoded detection signal in the parameter domain to time domain, the second converter applying an inverse transform of the transform of the first converter.

The system may include a band-pass filter disposed between the first converter and the decoder to remove signals around selected frequencies to stabilize the decoding operation.

In yet another aspect of the invention, there is provided a method for generating synthetic transmit aperture (“STA”) signals and processing received synthetic aperture imaging (“SAI”) signals. The method includes the steps of selecting a plurality of transmission schemes, each of the plurality of transmission schemes specifying a signal source to be used to activate each one of the transmitting elements in the transmission event; transmitting at the plurality of transmitters pulse wave signals toward an image object in a plurality of transmission events, in each transmission event of the plurality of transmission events only signal sources being identified in the corresponding transmission scheme being used to activate the transmitting elements according to the transmission scheme; receiving at a plurality of receivers backscattered waves from the image object and measure the detected signal to obtain measured detection signals at the plurality of receivers; converting the measured detection signals to a parameter domain by applying a transform implemented by a first signal converter; decoding from the measured detection signals in the parameter domain equivalent detection signals at the plurality of receivers as if only one transmitting element was transmitting in each one of the transmitting event; and converting the equivalent detection signals from the parameter domain to time domain by applying a inverse transform of the transform implemented by a first signal converter, the inverse transform being implemented by a second signal converter.

As a feature of this aspect of the invention, the method further includes the step of reconstructing an image from the equivalent detection signals in the time domain by applying an SAI process.

In yet another aspect of the invention, there is provided a method of retrofitting a synthetic aperture imaging device that includes an array of transmitting elements, an array of a receiving elements, a signal source for generating a pulse signal, and an SAI unit for reconstruct an image. The method includes the steps of providing a time delay array disposed between the signal source and the array of transmitting elements, said time delay array having delay elements for introducing individually controllable time delays to signals sent from the signal source to each transmitting elements, providing a controller, said controller controls the individually controllable time delays specified in a transmission scheme, said transmission scheme specifies one or more transmitting elements of the array of transmitting elements to transmit pulse signals in a transmission event and a time delay associated with each of the pulse signal transmitted in the transmission event, providing a first converter, said first converter being constructed to implement a transform for converting time series detection signals measured at the array of receivers to a parameter domain by applying the transform, providing a decoder, said decoder being constructed to decode from the measured detection signals in the parameter domain equivalent detection signals at the array of receivers as if only one transmitting element was transmitting in each one of the transmitting event, and providing a second converter, said second converter being constructed to implement an inverse transform for converting the equivalent detection signals from the parameter domain to the time domain to estimate a set of equivalent SAI data signals, said set of equivalent SAI data signals being provided to the SAI unit for reconstruct the image.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1A is a schematic diagram illustrating a setup of a system for generating and acquiring data signals that are suitable for the DE-SAI method described herein;

FIG. 2 is a schematic diagram illustrating a general system that includes multiplexers for selecting transmission and receiving schemes at the same time and processing the acquired signals;

FIGS. 3(a) and 3(b) illustrate a triangular transformation to transform an original output channel-transmission event triangle, shown in FIG. 3(a), to an output channel-transmission event triangle rectangle as shown in FIG. 3(b) to reduce the number of the receiver channels by half;

FIG. 4 shows steps of a process implementing the DE-SAI method using a system such as that illustrated in FIG. 1 for obtaining an image with improved spatial resolution and SNR;

FIG. 5 shows transmission of signals by a linear array of transmitters in a sequence of four transmission events;

FIG. 6 illustrates an intermediate step of extending a 2×2 time delay encoding matrix to a 4×4 time delay encoding matrix, whereby positive 1's in the initial 2×2 matrix H₂ are first replaced by H₂ and negative 1's are replaced by the negative of H₂;

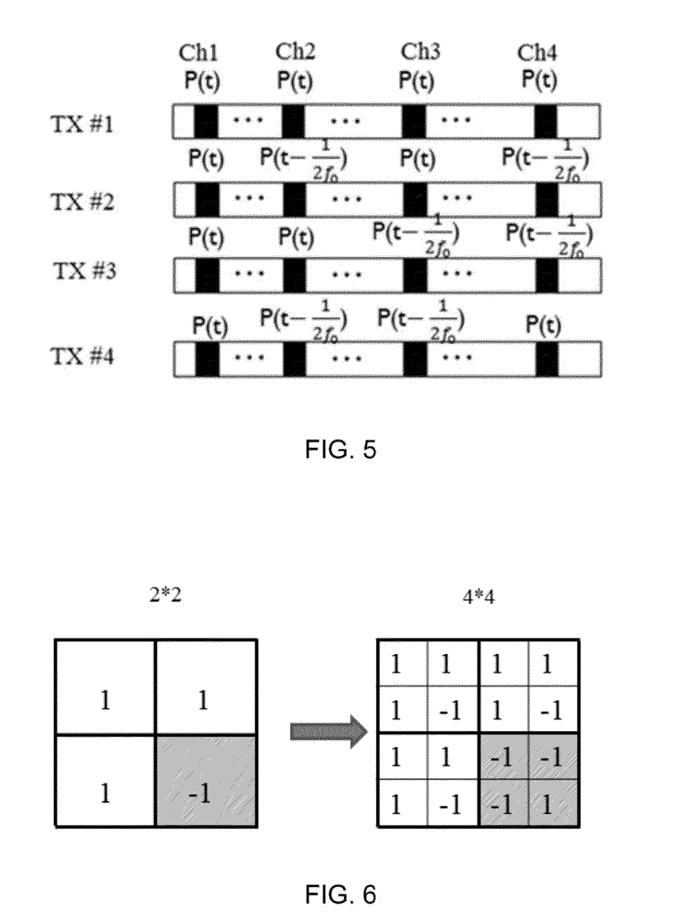

FIG. 7 shows a comparison of images obtained through (a) B-mode imaging, (b) traditional SAI imaging and (c) SAI imaging with time delay described herein; and

FIG. 8 shows an example of hardware implementation for Hadamard receiving encoding scheme.

### DETAILED DESCRIPTION OF EMBODIMENTS

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

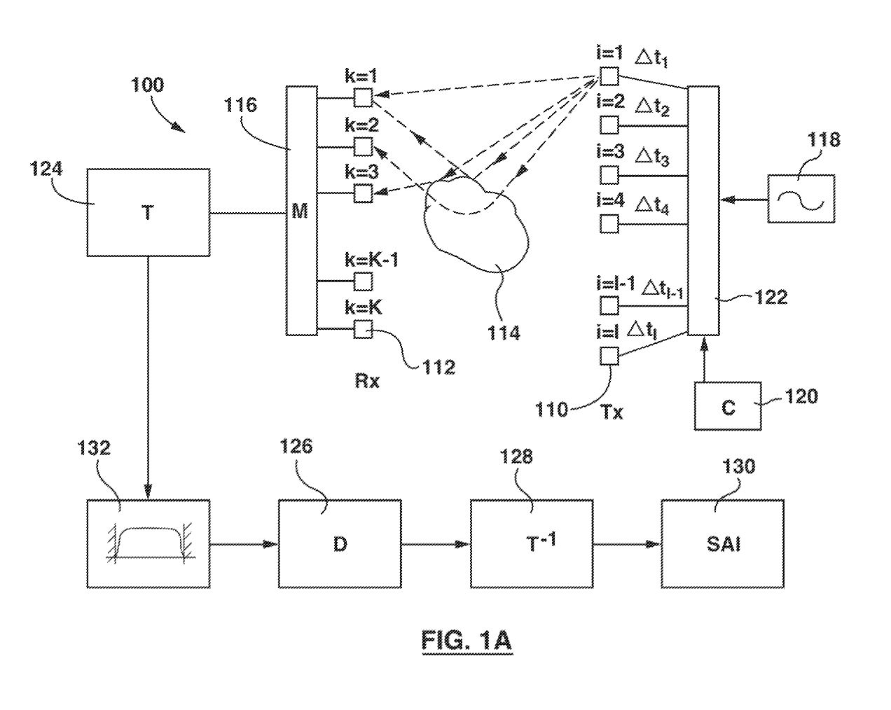

FIG. 1A is a diagram that illustrates a setup of a system 100 for generating and acquiring data signals that are suitable for the DE-SAI method described herein. The setup includes an array of transmitting elements 110 and another array of receiving elements 112. The array of transmission elements may be a linear probe array of a commercial ultrasound medical imaging device or a probe array of a sonar system, or an array of detonators in a seismic survey system. The array of receiving elements may be the same linear probe array such as in a commercial ultrasound medical imaging device, a separate array of signal detectors as in a sonar system or a seismic survey system. There may be equal number of receiving elements 112 as in the array of transmitting elements 110, but in general, the total number of receiving elements 112, K, is not the same as the total number of transmitting elements 110, I. Each transmitting element is driven by a pulse signal and emits a pulse wave towards a detection object 114. Back scattered waves from the detection object are measured at each receiving elements to generate measured detection signals 116. In one transmission event, one or more transmitting element may be transmitting. These transmission elements may be driven by a common signal source 118, such as in a commercial ultrasound medical imaging device, or may be driven individually such as in an array of detonators in a seismic survey system. Time delays are introduced at each transmitter in a transmission event by, for example, a controller 120. This may be to control the detonation of individual detonations, or to control a time delay element array 122 between the common signal source and the individual transmitting elements, to insert delays into pulse signals as they are sent from the common signal source to individual transmitting elements. In one example, all delays are a half-period delay, with respect to a central or reference frequency.

Measured detection signals are converted to traditional SAI image data, i.e. as time series data at each output channels, such as individual or combined receiving elements, as if only one transmitting element was transmitting in each transmission event. To perform this conversion, the measured detection signals are converted by a transform converter 124, a decoding converter 126 and an inverse transform converter 128, in that order. Each of the transform converter, the decoding converter and the inverse transform converter is constructed to perform a signal conversion according to the method described herein. These converters may be constructed as hardware or firmware to implement the conversions described herein. They may also be implemented in software as software modules. An SAI unit 130 or SAI module next can apply any known SAI techniques to reconstruct an image from the traditional SAI image data obtained from the consecutive application of these conversions.

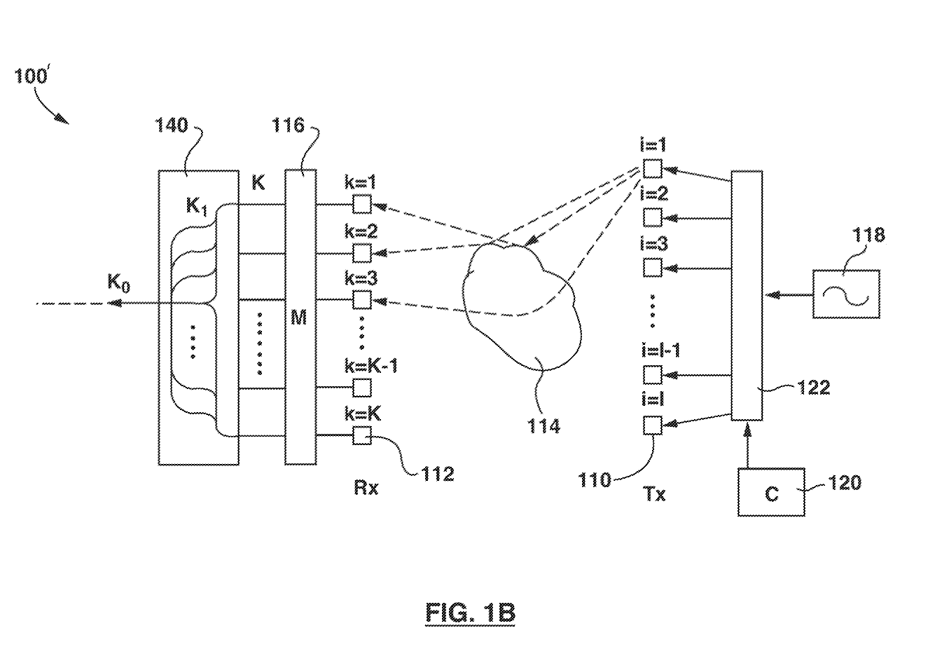

As will be appreciated, although FIG. 1A is intended to illustrate the setup of a system 100 for generating and acquiring data signals that are suitable for the DE-SAI method described herein, this also illustrates in general a retrofitted system that originally was not designed to be capable of DE-SAI imaging. Such an original system may include the array of transmitters 110 and the array of receivers 112, together with a common signal source 118. It may (or may not) have an SAI unit for reconstructing an image from SAI data. To retrofit such a system, there is provided a time delay element array 122 between the common signal source and the individual transmitting elements, controlled by a controller 120, so that time delays at individual transmitting elements can be separately controlled. This will enable different transmission schemes to be implemented. Also will be required for such a retrofitted system will be a transform converter 124, a decoding converter 126 and an inverse transform converter 128 as described herein for converting the measured detection signals. The resulting equivalent traditional SAI image signals can be sent to the original system's SAI unit for further processing, to reconstruct an improved image. Of course, if the original system did not have an SAI unit, then such an SAI unit will need to be included in the retrofitted system. More is described in reference to FIG. 2.

The system 100 illustrated in FIG. 1A is an example of a special class of a more general system 100′, illustrated in FIG. 1B. Referring to FIG. 1B, there is illustrated a portion of a more general system 100′. Only the transmitting and receiving portions are illustrated. The other portions, namely, transform converter 124, decoding converter 126 and inverse transform converter 128 are the same as described in connection with system 100. What is not provided in system 100 but in system 100′ is a signal combiner and selector 140. Signal combiner and selector 140 combines measured detection signals 116 generated at K receivers into K₁ output channels. Then, instead of selecting K₀ signals directly from K receivers, signal combiner and selector 140 selects K₀ output channels from K₁ output channels combined from K receivers and forward the selected K₀ signals at the K₀ output channels to K₀ electronic processing unit, represented by transform converter 124, decoding converter 126 and inverse transform converter 128, for further processing and data acquisition. How to combine these measured detection signals will be described in detail later. As an example, four adjacent elements in the receiver array may be combined together as one receiver in the receiving mode. This will reduce the receiving channel number to K/4. As a special case, which is described above in connection with system 100, all receivers are treated as output channels, i.e., signal combiner and selector 140 do not combine signals at receivers. Then, K₀ receivers out of K receivers are simply selected and connect to the K₀ receiving electronics for data acquisition.

FIG. 2 illustrates a system 200 for acquiring improved image signal data and for processing the improved image signal data. System 200 illustrated in FIG. 2 has an array of transmitters, namely a transmitter array 202, that is coupled to a transmission multiplexer MUX_T 206. System 200 also has an array of receiving elements, namely a receiver array 208, that is coupled to a receiver signal combiner and selector MUX_R 212. Transmission multiplexer MUX_T 206 transmits analog wave signals, optionally first converted by a DAC 214 from a digital generator (not shown) and further amplified by HV AMP 216 before provided to MUX_T 206 to drive the transmitter array 202. The digital wave signals may be generated by a common signal source (not shown) or generated or routed by a central control processor 218. As is known to one skilled in the art, DAC 214 is the unit to convert digital signals to analog signals, and high voltage amplifier, i.e., HV AMP 216, increases the amplitude of the analog signals. In some applications, such as an ultrasound medical imaging system, the transmitter array and the receiver array may be combined into a transducer array 220. In such a transducer array, each of the transmitting elements may also be used as a receiving element. In order to use the transducer array as both transmitter array, which is driven by signals from MUX_T 206, and also as a receiver array, which sends measurement data to MUX_R 212, a transducer switch 222 is provided to connect the transducer array 220 to the MUX_T 206 during transmission and to connect the transducer array 220 to MUX_R 212 during signal detection or measurement.

Signals received at and by receiver array 208 are processed by receiving electronics unit 224. These signals from receiver array 208 are combined at MUX_R 212 to form K₁ output channels, from which K₀ output channels are selected and then routed to receiving electronics unit 224 by receiver signal combiner and selector MUX_R 212. Receiving electronics unit 224 may include, for example, a TGC/Filter module 226, to control signal gain, and an ADC unit 228, to convert data from analog to digital. Signal data processed by receiving electronics unit 224 may be optionally stored to memory storage device 230, and then further processed, or directly sent to processing units for imaging processing. For example, the acquired data signals may be passed first through a band-pass filter, BP filter 232, subsequently decoded for traditional STA data by signal decoder 234, and then further processed by a DAS beamformer 236 to generate displayable image data, which can be displayed to a user on display 238.

Transmission signals applied to and transmitted by each of the transmitting elements may be generated locally and synchronized with other transmitters, or all come from the same signal or function generator. In one implementation example, all transmission elements will be used in every transmission to maximize the energy for signal. Transmission patterns specify how the different outputs of a function generator are connected to different transmitters. For example, function generator can have two outputs, which can be derived from one basic waveform w₀(t). These two outputs may be any two of: (1) basic waveform w₀(t) and its delay w₀(t-delay), where delay may be the half period corresponding to a central frequency; (2) basic waveform w₀(t) and its invert −w₀(t); and (3) w₀(t) and 0, where 0 means grounding. The transmission patterns are defined using a transmission matrix. The l-th row of the transmission matrix is the l-th transmission pattern. The elements of the rows (or the transmission matrix) are either 1 or −1. If the i-th element of row l is 1, the transmitter i in the l-th transmission is connected to the first output of the function generator. If the i-th element of row l is −1, the transmitter i in the l-th transmission is connected to the second output of the function generator. MUX_T implements this selection.

As shown in FIG. 2, transmitter multiplexer MUX_T 206 couples (or connects) transmitter array 202 to high voltage amplifiers HV AMP 216, and is controlled by central control processor 218. MUX_T 206 applies the transmission scheme to the transmitter array 202, for example, by applying different time delays Δt and weight factors c_li to encode the transmission. In one embodiment, the transmission scheme takes the form of a transmission matrix, or more particularly a Hadarmard matrix with the size I in the case L=I, so that c_li is either +1 or −1. In this case, HV AMP 216 is configured to provide two outputs: (1) w₀(t) and w₀(t-delay), delay Δt may be the half period corresponding to a central frequency; (2) w₀(t) and −w₀(t). MUX_T 206 connects a transmitter to one of these two outputs according to the value of element Hₗᵢ. For example, if Hₗᵢ is 1, then the i-th element will be connected to the first output from the HV AMP 216 in the l-th transmission; if Hₗᵢ is −1, then the i-th element will be excited by the second output from the HV AMP 216 in the l-th transmission.

On the other hand, a receiver scheme may be applied to the receiver array 208 in a transmission event. The receiver scheme combines all the K available receiving elements (or some, if only some are active, desirable or needed) to form K₁ output channels in a transmission event and then selects portion of the K₁ output channels, namely selects only K₀ output channels, to connect to the receiving electronic unit. This will be useful for reducing the number of receiver channels in the receiving electronics unit 224 to handle all active receiving elements in the receiver array 208. A receiver scheme specifies the way to combine all (or some of) the K available receiving elements to form K₀ output channels. One unit in which to implement a receiver scheme may be receiver signal combiner and selector MUX_R 212. A special receiver scheme is that all the K available receiving elements are combined according to a K-th order Hadamard matrix (or any other K by K encoding matrix) to form K output channels. Then in each transmission, a specific set of K₀ output channels are selected from the K output channels. A special class of receiver schemes is one that each of the receiving elements is combined with only itself to form K output channels, i.e., receiving elements are selected and directly connected to receiving electronic unit, without being combined first.

As illustrated in FIG. 2, receiver signal combiner and selector MUX_R 212 couples (or connects) the receiver array 208 to the receiving electronics unit 224 (e.g., TGC and ADC), and is controlled by a central control processor 218. All of the selected (e.g., all K available) receiving elements are combined to form K₁ output channels and then different output channels are selected by MUX_R 212, according to a receiving scheme, which may be in the form of a receiving matrix R, in each transmission. Any suitable method may be employed to combine and select output channels for each transmission event and to select different output channels from transmission to transmission. For example, to select K₀ of K receiving elements to measure signals during each transmission, one may select randomly K₀ numbers out of K₁ possible numbers (total number of output channels combined from K available receiving elements) as the output channel indices, i.e., the indices of the output channels to be connected to the receiving electronics. For another transmission, i.e., another line of the receiving matrix R, another set of such K₀ random numbers may be selected and used. Alternatively, instead of selecting random indices, one may optimize the selections. For example, one criteria to optimize R is that for any receiver, it receives data in L*K₀/K transmission events (which is the average number of measurements by each receiving element after considering multiplexing the receivers), and that, for the L*K₀/K transmission events, the selected transmission patterns are as different as possible from transmission to transmission. Or as further alternatives, indices of R can be chosen uniformly from 1 to K₁ by incrementing the next index by K₁/K0, or the same indexes for one transmission can be used for all transmissions (i.e., a fixed subset of receiving elements are used for all transmissions).

The transmitter multiplexer MUX_T 206 enables one to select different transmission patterns, or transmission schemes, from transmission to transmission, for example, to vary time delay patterns as applied to transmitting elements from transmission to transmission. The receiver signal combiner and selector MUX_R 212, in addition to combining receiving elements to form output channels, enables one to select different receiving schemes from transmission to transmission, namely to form/select different output channels from transmission to transmission. As a special case, one possible receiver scheme is to select all output channels for all transmissions. Another possible receiver scheme is to select output channels in such a way to take advantage of transmit-receive symmetry to reduce the receiving channels by about half without compromising the image quality. This is further explained below.

In standard STA, the signal received at i-th receiver and transmitted by the j-th transmitter is equivalent to the signal received at j-th receiver and transmitted by the i-th transmitter. This transmit-receive symmetry property can be described using the equation pᵢⱼ=pⱼᵢ. A simple approach to utilize this symmetry in recovering standard STA data is to select output channels using a receiver scheme as illustrated in the pattern below (for L=K₀):

| | Output channels selected |
|---|---|
| Transmission #1 | 1 |
| Transmission #2 | 1, 2 |
| Transmission #3 | 1, 2, 3 |
| Transmission #4 | 1, 2, 3, 4 |
| . . . | |
| . . . | |
| Transmission #(L − 1) | 1, 2, 3, 4, . . . , (L − 1) |
| Transmission #L | 1, 2, 3, 4, . . . , (L − 1), L |

However, according to this scheme, although the number of output channels is reduced at the beginning of the transmission events, all the output channels would have been used for the final transmission event. To reduce the maximum number of data acquisition channels, i.e., to reduce the number of output channels selected for data acquisition, the available output channels are divided into two groups, such as channels from 1 to L/2 and channels from L/2+1 to L. In the first transmission event, an output channel, for example, channel #1, is selected from the first group and all channels from the second group are selected. In the second transmission event, an output channel, such as channel #2, from the first group is added to the selected group when another output channel, such as channel #L/2+1, from the second group is removed from the selection. This adding and removing process is repeated until all channels from the first group are selected and all channels from the second group are removed from the selected output channels. When L is an even number, only a maximum of L/2+1 channels are selected for any given transmission event. When L is an odd number, the number of maximum number of channels selected is (L+1)/2. This is illustrated in the pattern below (for an even L):

| | Output channels selected |
|---|---|
| Transmission #1 | 1, L/2 + 1, . . . L |
| Transmission #2 | 1, 2, L/2 + 2, . . . L |
| Transmission #3 | 1, 2, 3, L/2 + 3, . . . L |
| Transmission #4 | 1, 2, 3, 4, L/2 + 4, . . . L |
| . . . | |
| . . . | |
| Transmission #L/2 | 1, 2, 3, 4, . . . L/2 |
| Transmission #L/2 + 1 | 1, 2, 3, 4, . . . L/2 |
| Transmission #(L − 1) | 1, 2, 3, 4, . . . L/2 |
| Transmission #L | 1, 2, 3, 4, . . . L/2 |

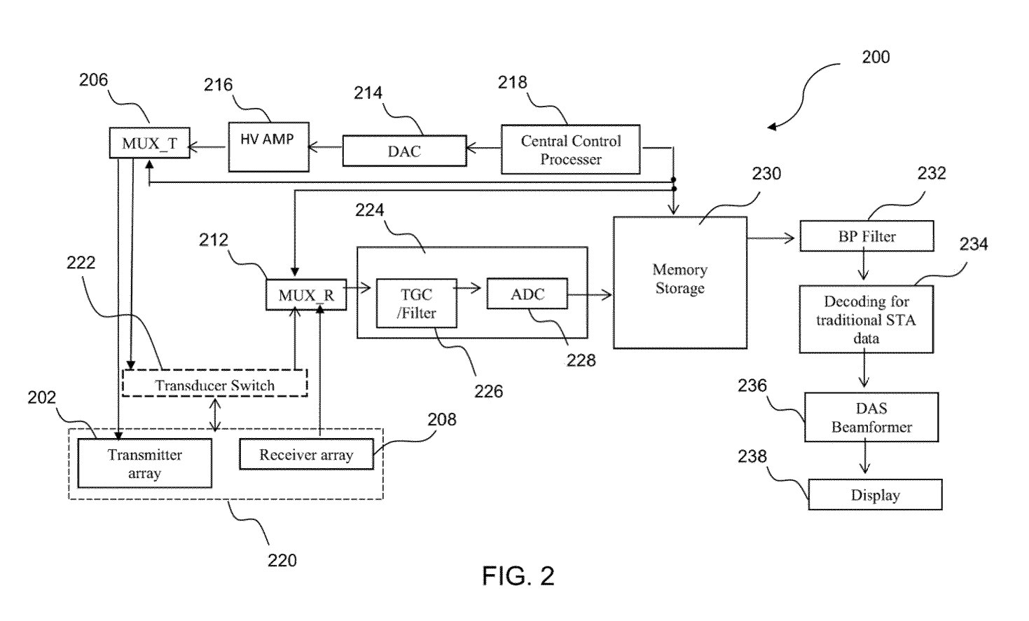

In this receiver scheme, one output channel is guaranteed to be used for every transmission (this is the first output channel in the pattern shown above). Visually, this pattern represents a triangular transformation illustrated in FIGS. 3(a) and 3(b), where an original output channel-transmission event triangle illustrated in FIG. 3(a) is transformed into an output channel-transmission event rectangle as shown in FIG. 3(b). This triangle pattern can also be extended to more complex configuration, in which combination of signals at the receivers is included. Using the triangle pattern can improve the stability of the decoding process and the image qualities of the reconstructed images.

It will be understood that for each transmission event, a transmission scheme may be independently selected, a receiving scheme may be independently selected (such as shown in the pattern above), a pair of transmission scheme and its corresponding receiving scheme may be selected together as a pair, or a transmission scheme and a receiving scheme can be both selected at the same time for a transmission event, even though they do not necessarily always correspond to each other. Central control processor 218 controls the transmission and receiving processes. The transmit patterns in the transmission matrix and the indexes of receiving elements in the receiving matrix are stored in a memory storage device 230 of the central control processor 218, retrieved by the central control processor and delivered to MUX_T 206 and MUX_R 212 before each transmission.

Band-pass filter, BP filter 232, is frequently used to filter out signals in certain frequencies or frequency range(s) that can cause artifacts. This is generally a useful component though not absolutely necessary, especially where no particular frequency or frequency range require filtering. The signal decoder 234 may be implemented in time domain, in frequency domain or in some other parameter domain. In a frequency domain, it may be implemented in a way similar to that illustrated in FIG. 2, which may include a first transform converter 124, decoding converter 126 in the frequency domain, and a second, inverse transform converter 128, as shown in FIG. 1. The implementation of the signal decoder will be further explained in greater detail later.

The systems illustrated in FIG. 1A, FIG. 1B and FIG. 2 and/or their combinations can be used to implement an improved method that generates modified wave signals for transmission by the transmitter array 110, 202 in a number of transmission events and decodes wave signals measured and received at a number of receiving elements 112, 204, receiving elements for each transmission events being selected according to a receiver scheme, the decoding taking into account the effects of the transmission schemes.

Broadly speaking, the method starts with selecting a number of transmission schemes, each such scheme to be applied to a transmission event. Such a transmission scheme specifies which signals (signal outputs) will excite each of the transmitting elements (e.g., where a function generator or HV AMP provides two outputs, specifies which one of the two outputs is used to activate each transmitter). In each transmission event, a pulse signal, which may have a finite frequency spread about a central or reference frequency and may come from a common signal source 118 such as a signal generator, is transmitted according to the transmission scheme by each one of one or more transmitting elements 110 of the transmitter array as pulse waves toward a detection object 114. In one embodiment, the transmitted wave signals are controlled by a central control processor according to the selected transmission schemes. The central control processor retrieves the transmission schemes from its memory storage device, enforcing the transmission schemes by directing a transmission multiplexer to connect different transmission elements to different signal outputs of the source, such as HV AMP 216, and/or introducing different time delays to different transmission elements by way of a time delay element array.

Backscattering of the pulse waves from the detection object 114 is received by array elements and combined to form output channels, as determined by the receiver signal combiner and selector MUX_R 212, and sent to a signal decoder for decoding. Not all receivers in a receiver array may be receiving in a transmission event. Only those specified in a receiver scheme are receiving signals in a transmission event, or only those specified will be connected to the receiving electronics unit 224 by the receiver signal combiner and selector MUX_R 212. Other receivers (or their corresponding output channels) either are not receiving or detecting signals, or their signal will simply be ignored. These wave signals measured at each receiving elements form a collection of measured detection signals m. Each collection of measured detection signals corresponds to a transmission event, each measured detection signal m being received by a receiving element of the array of receiving element as time series data corresponding to measured time variation of backscattered wave signal at the receiving element. The collections of measured detection signals are combined and selected, the selection of measured detection signals, i.e., collection of data signals at output channels selected in transmission events, is decoded to estimate a set of equivalent traditional SAI data. The decoding may be performed in time domain, which may be particularly suitable when the transmission schemes do not introduce any time delays. The decoding may also be performed in a frequency or some other parameter domain, to reduce noise or increase SNR further. A detailed example will be given on decoding in a frequency domain. The resulting equivalent traditional SAI image data is then processed according to any SAI techniques to reconstruct the image, by using, for example, a DAS beamformer.

As noted, a special class of receiver scheme is not to combine outputs from receiving elements into output channels, but to select output channels directly from portion of receiver array. The following will use this special case to illustrate the principle of decoding signals and reconstructing SAI images from signals received from portion of receiver array. Examples of combining signals measured at receivers first into output channels prior to decoding and reconstruction will be provided later.

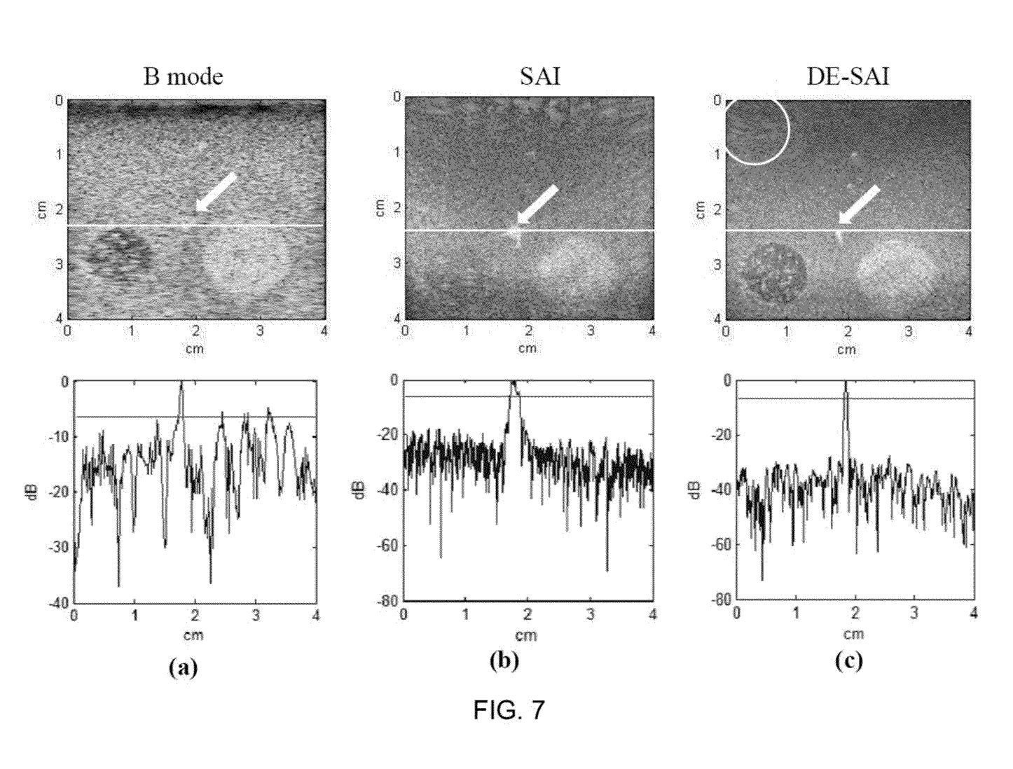

Reference is now made to FIGS. 3 to 5, illustrating steps of a method of generating delay-encoded STA signals as a special case of the method described above and processing the image signals for obtaining SAI image data with better SNR, and to FIG. 7 which shows examples of comparisons demonstrating the improvements. This is a time delay-encoded transmission scheme method. This method starts with selecting a number of transmission schemes 310, each such scheme to be applied to a transmission event. Such a transmission scheme specifies which of the elements of the transmission array transmit in the transmission event, and time delay associated with each one of the transmitting elements in the transmission event (and a waveform modification factor, such as a constant weight factor which may be applied to a common waveform). In each transmission event, a pulse signal, which may have a finite frequency spread about a central or reference frequency, is generated by a common signal source 118 such as a signal generator, and transmitted according to the transmission scheme (step 420) by one or more transmitting elements 110 of the transmitter array as pulse waves toward a detection object 114. Backscattering of the pulse waves from the detection object 114 is received by and measured at each receiving element of an array of receiving elements 112. These wave signals are measured at each receiving element (step 430), which generates a collection of measured detection signals m. Not all receivers may be used in a transmission, nor all receiver elements may be receiving signals. Only those specified in a receiver scheme are active. Each collection of measured detection signals corresponds to a transmission event, each measured detection signal m being received by a receiving element of the array of receiving element as time series data corresponding to measured time variation of backscattered wave signal at the receiving element. The collections of measured detection signals are converted from time series data to a parameter domain (step 440), such as frequency domain, by applying a transform T, such as a Fourier transform. The converted measured detection signals M, now in a parameter domain, are decoded (step 450) to estimate a new set of data, which corresponds to data signals P that would be obtained if only one transmitting element was fired in each individual transmission event. The decoded data signals are further converted to estimate values of P in time domain (step 460) by applying an inverse transform T⁻¹ thereto. The resulting equivalent traditional SAI image data is then processed according to any SAI techniques (step 470), to reconstruct the image. This is further described in detail below.

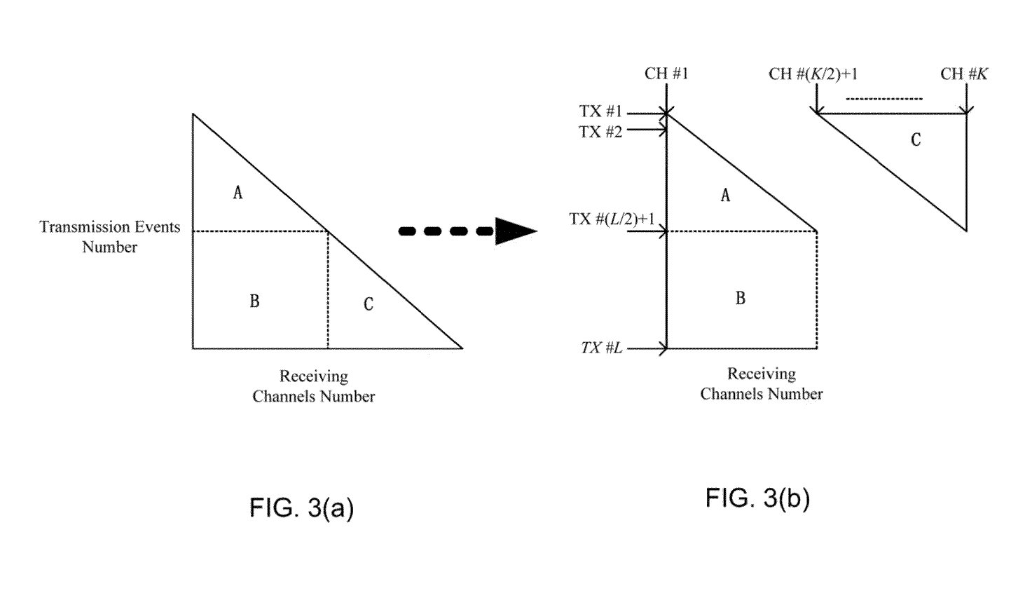

Referring to FIGS. 1A and 2 to 5, in order to generate a set of usable SAI image data, the transmission array transmits pulse wave signals towards a detection object in a series of transmission event. In each transmission event, one or more transmitter elements transmit time-delay encoded and/or waveform modified pulse signals. The time-delay encoded and/or waveform modified pulse signals may all be from a single signal source, such as a signal generator, with specified time delays added or modification to waveform applied as the signals are sent from the signal source to each individual transmitting element. For example, referring to FIG. 4, in one time-delay encoding scheme, no delay is applied to any transmitting element and all transmitting elements are transmitting the same pulse signal. Each channel then all have the same pulse signal p(t). In another time-delay encoding scheme, there is no time delay for the first transmitting element (Δt₁=0), there is a time delay of Δt₂=1/(2 f₀) for the second transmitting element, no delay (Δt₃=0) for the third transmitting element, a time delay of half period (Δt₄ 1/(2 f₀)) for the fourth transmitting element, so on and so forth. For a total of L transmission events, L such time-delay encoding scheme are first specified. As will be understood, although in FIG. 4, all illustrated elements are shown to be transmitting, this is not required. In other words, in addition to time delay variation, some transmitting elements (of the array) may not transmit in some of the transmitting events.

In this example, each transmitter that transmits in any transmitting event may be driven by the same signal source. A time delay is added between the signal source and the transmitting element. Each transmitter therefore transmits the same pulse signal, other than the time delay at different transmitters. The time delay may be implemented through hardware, such as by configuring a field-programmable gate array disposed between the signal source and the transmitting element or other suitable special circuits for delay control such as ultrasound transmission focusing circuit. This delay also may be implemented via software control. Additionally, although it would increase the signal strength if all transmitting elements transmit in each transmitting event, it is not required. In other words, some of the transmitting elements may be selectively turned off, e.g., not fed with a pulse signal or prevented from transmitting, in some of the transmitting events. Further, although it is convenient to supply a pulse signal from a common signal source, with individualized time delays applied to each of the channels, it is entirely possible to supply individualized pulse signals to each of the transmitting elements from separate signal sources, such as providing a signal generator corresponding to each transmitter. This may be useful in a system where transmitters are separated at great distances, such as in a seismic survey system.

In each transmission event, data signals are measured by receiver elements of the array of receivers (step 430) to generate a collection of measurements m(t). Measurement at each receiver is a summation of signals from all transmitters, either coherently or incoherently as the case may be. In general, there may be a total of K such receiver elements which is not equal to I, the number of transmitters, though in a special case where the same transmitter array is also used as receiver array, K is the same as I. Individual measurements at each transmitter k together form the collection of measurements, in one transmission event. After all L transmission events are completed, there is collected the entire measurement data set 116, M(t).

This can be expressed more precisely as follows. Consider an example of L transmission events in a data acquisition for forming a high-resolution image. In each transmission, a total of I transmitting elements (the same I elements for all the L transmissions) are fired with various time delays assigned to individual transmitting elements, according to the transmission scheme. In the l-th scheme (i.e., for the l-th transmission), the i-th element of the I elements has a time-delay of Δtₗᵢ, measured from a reference time, such as t=0. When there is no delay, Δtₗᵢ is 0. In the linear case, the received signal at a receiver k, when multiple transmitting elements are fired together, equals to the summation of the equivalent received signals when the same multiple transmitting elements are fired individually but with the same delay. Thus, in the l-th transmission event, the data signal received by the k-th receiving element is

Σᵢ₌₁^{I}pᵢₖ(t−Δtₗᵢ)=mₗₖ(t) (1)

where pᵢₖ(t) denotes the equivalent traditional STA data, i.e., an equivalent pulse signal data received by the k-th receiving element when only a particular i-th transmitting element is excited by the pulse signal. The matrix M(t), with elements mₗₖ, forms the measured detection signal data.

In a more general scenario, apodization or other factors may give different weight at each of the receiving element. Therefore, the data signal received by the k-th receiving element should include a weight assigned to each receiving element in each of the transmission event:

Σᵢ₌₁^{I}Cₗᵢpᵢₖ(t−Δtₗᵢ)=mᵢₖ(t) (1′)

where cₗᵢ is the weight factor (which may have a functional form or as a positive or negative constant) that is assigned to the i-th transmitting element in the l-th transmission event. As will be described in one special example, one particular form of cₗᵢ is a series of +1 and −1.

The measured detection signal data is next converted by a converter or conversion module at step 440. The conversion is to apply a transform to the measured detection signal data M. The transform T is a transform of the time delay of the transmission signal, one example of which is a Fourier transform, which transforms the measured detection signal data m(t) from time domain to frequency domain. In general, the transform T { } must be such that, T {ƒ(x−d)}=T{ƒ(x)}*G(d), i.e., the transform of the delay d of a function ƒ(x) (or a segment of signal), i.e., ƒ(x−d), can be represented as the multiplication of the transform of the function or signal ƒ(x) itself and another function G(d) that includes the delay d as its variable. In the Fourier transform example, in the frequency domain, Mᵢₖ (f) is the Fourier transform of the measured signal mᵢₖ(t) (which is in time domain).

At step 450, the converted data is subsequently decoded, the decoder property being selected according to time delays assigned to each transmitting elements in each transmission event, namely the transmission scheme of each transmission event. The decoder generates the equivalent signal at each receiver, as if measured when only one transmitting element was fired at one time. The decoder property is also determined by the transform applied by the converter. This is further explained below.

In the Fourier transform example, applying a time-delay Δtₗᵢ to the equivalent received signal pᵢₖ(t) is equivalent to multiplying the signal spectrum Pᵢₖ(f) by a factor of Aₗᵢ(f)=cₗᵢe^{-j2πfΔt}^{ₗᵢ} in the frequency domain. Here, f is an arbitrary frequency in the spectrum and j is the imaginary unit. In the special case where cₗᵢ=1, i.e., no weight applied, Aₗᵢ(f)=e^{-j2πfΔt}^{ₗᵢ}. After applying Fourier transform to both sides of Equation (1) (or more generally, Equation (1′)), at any frequency f, we have

Σᵢ₌₁^{I}Aₗᵢ(f)Pᵢₖ(f)=Mₗₖ(f) (2)

Therefore, the decoder must apply a transform A⁻¹ to M(f), the elements of M(f) being Mₗₖ(f):

P=DM (3)

where D=A⁻¹. In Equations (2) and (3), A is the coding matrix and D is the decoding matrix. A, D, P, M are matrices with elements of Aₗᵢ(f), Dₗᵢ(f), Pᵢₖ(f) and Mₗₖ(f). Each column of A corresponds to a particular transmitter element position i, while each row stands for a separate transmission scheme in one transmission event l.

More generally, however, it will be appreciated that in solving Equation (3), decoding matrix D may not necessarily be exactly A⁻¹, such as will be explained below in the pseudo-inversion example. Further, D does not even need to be a square matrix. For example, when the total number of measurements L is not the same as the total number of receiving elements K, D will not be a square matrix. In situations like this, finding D=A⁻¹ or solving Equation (3) directly from P=DM may not be the best approach. In addition, even an explicitly defined decoding matrix D may not be necessary for solving Equation (3). Equation (3) may be solved, for example, by employing an iterative optimization method. Equation (3) here is merely to illustrate that the converted measurement data, M, now in a parameter domain, is to be decoded according to a suitably selected decoding transformation. Selecting D=A⁻¹, where Aₗᵢ(f)=cₗᵢe^{-j2πfΔt}^{ₗᵢ}, is only one such example. Selecting a decoding matrix D generated from a Hadamard matrix in the pseudo-inversion example is another. The methods, and the systems implementing the methods, are not limited to these examples.

As a generalization or alternative to Equation (3), P=D M, an equivalent traditional STA signal matrix may also be solved from a re-arranged p_{vector} when signals at the receiver elements are combined and selected for K₀ electronic units to process.

A p_{vector} having n×m elements is re-arranged from the STA signal matrix p which is an n×m matrix, by concatenating m columns of the matrix, i.e., by assigning p(i,j) as follows:

p_{vector}(i+(j−1)n)=p(i,j)

Instead of solving for the n×m matrix p, one solves for the p_{vector} that has n×m elements from the following set of L×K₀ equations (L transmission events, each event having K₀ output channels):

Eₗ*p_{vector}=mₗ,l=1:L (3′)

In this set of equations, mₗ is the measurement vector during a particular transmission event, l. Each element of the measurement vector mₗ is the data signal at one of the selected output channels. Output channels are formed by combining measurements of data signals at receiving elements. As described earlier, not all output channels are always selected for further data acquisition and processing operations. For convenience, the number of selected output channels, or K₀, stays the same for all of the L transmission events, to facilitate recovery of p_{vector} from a set of equations that has a more regular form, such as Equation (3′).

Eₗ is an encoding operator. Encoding operator Eₗ captures both the transmitters' encoding, such as time delay, amplitude apodization, as represented by the vector Tₗ (in frequency or time domain), and the combination of receiver elements and selection of output channels, as represented by Rₗ through MUX_R.

More specifically, in time domain, vector Tₗ encodes the transmission through MUX_T, the i-th element of vector Tₗ being the weight applied to the i-th transmitter through MUX_T in the l-th transmission. All vectors Tₗ, l=1:L, form an I×L matrix in time domain, whose counterpart in frequency domain is A (or D⁻¹ in Equation (3)).

For signal measurements, assume s(l,j) is the signal from the j-th receiver element in the l-th transmission, and mₗ(i) is the signal from the i-th output channel in the l-th transmission after the signal combiner, the application of MUX_R to s(l,j) may be represented by the expression,

mₗ(i)=Σⱼ₌₁^{K}s(l,j)·Rₗ(j,i) (4)

where Rₗ(j,i) is the weight applied to the j-th receiver element to generate the i-th output channel signal. When Rₗ(j,i) is an identify matrix, i.e., when there is no combination of signals from different receivers, mₗ(i)=s(l,i). The STA signal matrix p is recovered from Equation (3) as described above. When Rₗ(j,i) is not an identify matrix, i.e., when signals from different receivers are combined into output channels, instead of recovering STA signal matrix p, the equivalent p_{vector} is recovered from

Tₗ*p_{vector}*Rₗ=mₗ

which may be re-written as, using R^{T}ₗ, the transpose form of Rₗ,

R^{T}ₗ [symbol] Tₗ*p_{vector}=mₗ (3″)

With the definition of an encoding operator, Eₗ=R^{T}ₗ [symbol] Tₗ, where [symbol] is the Kronecker product, Equation (3″) is the same as Equation (3′). This equation can be used to recover STA signal vector p_{vector} from the measurement vector mₗ, namely from data signals at the selected output channels, combined and selected by MUX_R according to receiver schemes, from data signals at receiving elements or receivers.

As noted, matrices in Equations (2) and (3) are all in frequency domain. It is worth noting that when f equals to 0 or 2f₀, the coding matrix A takes the form of a square matrix that has all the elements being 1. Such a matrix cannot be inversed stably. The decoder thus cannot stably decode signals at f=0 or 2f₀. To deal with this, the signal is processed by a band-pass filter 132 disposed between transform converter 124 and decoding converter 126 to remove signals at and around f=0 or 2f₀ to stabilize the decoding operation. When the decoder is implemented as software module, a step is added to remove signals at and around f=0 or 2f₀ and then the filtered signals are further processed by the decoder module, to stabilize the decoding step.

As will be appreciated, that elements of the encoding matrix A have the special form of a complex exponential function is only one example. Elements of A are not restricted to such simple form. For example, elements of the encoding matrix can be an arbitrary function so that apodization or temporal encoding also can be applied. Further, the decoding is also not necessarily in frequency domain as is in the case of Fourier transform, but may be in any other suitably selected parameter domain.

At step 460, image data obtained from the decoder, which applies the decoding operation to its input data signals, such as an operation according to Equation (3), is further converted by an inverse converter or inverse conversion module, which applies an inverse transform of T, namely T⁻¹, to convert the image data M from parameter domain, such as frequency domain, to time domain, suitable for further SAI processing. In the Fourier transform example, the inverse converter transforms P(f) from frequency domain to time domain by applying an inverse Fourier transform to the image data P(f). An improved image data P(t), in time domain, is obtained from P(f). An improved image can be reconstructed at step 470, after applying further SAI processing to P(t), which may be implemented using any known SAI techniques.

FIG. 7 illustrates the improvements to both SNR and spatial resolution obtained in several experiments. The experimental data were acquired using an Ultrasonix RP research platform equipped with a parallel channel acquisition system SonixDaq (Ultrasonix, CA). The ultrasound probe was L14-5, which is a 4 cm-wide flat linear array probe with 128 elements that may be used as both transmitters and receivers. The transmission scheme was controlled by Texo, a development toolkit provided by Ultrasonix. The central frequency f₀ of the transducer was 5 MHz and data was sampled at 40 MHz. The tissue mimicking phantoms were made of degassed water (93.85% of total weight), gelatin powder (4.69%), polyethylene oxide (scatter) (1%) and formaldehyde (0.46%). In the background of the phantoms, the scatter concentration was 1% of the total weight, while inside the hyper-echoic inclusions the scatter concentration was twice of that and the hypo-echoic inclusions had no scatters.

Referring to FIG. 7, there is shown a comparison of images obtained through (a) B-mode imaging, (b) traditional SAI imaging and (c) SAI imaging with time delay encoded SAI (DE-SAI) imaging described herein. The imaged object is a 4 cm by 4 cm square phantom that contained both a hyper- (on the right side) and a hypo-echoic (on the left) inclusion with a diameter of 1.2 cm as well as three wire inclusions of 0.5 mm diameter. Both the spatial resolution and the SNR of the DE-SAI were improved compared with those of the B-mode and the traditional SAI images. Both the circular inclusions and the wire inclusions are better detected. The bright dots inside the hypo-inclusion (probably due to air bubbles) can also be clearly seen after DE-SAI reconstruction. The line plots (second row of each of FIG. 7 (a), (b) and (c)) further demonstrated that the spatial resolution and SNR from one of the wire inclusions (denoted by the white arrows) have been enhanced: the lateral resolution was improved by 52% and 68% and the SNR was increased by 23.5 dB and 9.2 dB, compared with the B mode and the traditional SAI, respectively.

In practice, measurement M may be contaminated by noise. This may lead to instability when decoding P from M by the decoder D, especially when A has a large condition number, or very small singular values in SVD. Any small noise in the measurement would be overemphasized after a simple inversion without regularization, thus leads to instability. To overcome this difficulty, decoder D may be modified or constructed to avoid applying decoding operation at the small singular values. This is regularization, which tends to provide more stable decoding results. This is further explained below.

To better understand the pseudo-inversion operation, consider first in general terms a singular value decomposition (SVD) method. According to this method, one first selects two orthonormal matrices U and V. Their i-th columns are, respectively, uᵢ and vᵢ and U=(u₁, u₂, . . . , u_{L}) and V=(vᵢ, v₂, . . . , v_{L}). The complex conjugate transpose of U is U* and the complex conjugate transpose of V is V*. All singular values σᵢ of A are extracted from A to form a diagonal matrix S. Conveniently, the singular values σᵢ of A can be arranged in a non-increasing order along the diagonal of S, i.e., σ₁≧ . . . σ_{L}≧0. Applying SVD of coding matrix A, we have

A=USV*=Σᵢ₌₁^{L}uᵢσᵢvᵢ* (5)

Because both U and V are orthonormal matrices, we also have

D=A⁻¹=VS⁻¹U* (6)

or

$$D = {A}^{- 1} = {\sum }_{i = 1}^{L} \frac{{v}_{i} {u}_{i}^{*}}{{σ}_{i}} \qquad ( 7 )$$

Careful choice of encoding matrix A may lead to both stable decoding process and improved SNR. In the decoding, the terms corresponding to very small singular values in the above equation can be ignored in decoding when the measured data are contaminated by noise. One such example is a special matrix H. This special matrix H is constructed in the following manner.

The process starts from a 2×2 Hadamard matrix

$${H}_{2} = [ \begin{matrix}1 & 1 \\ 1 & - 1\end{matrix} ] .$$

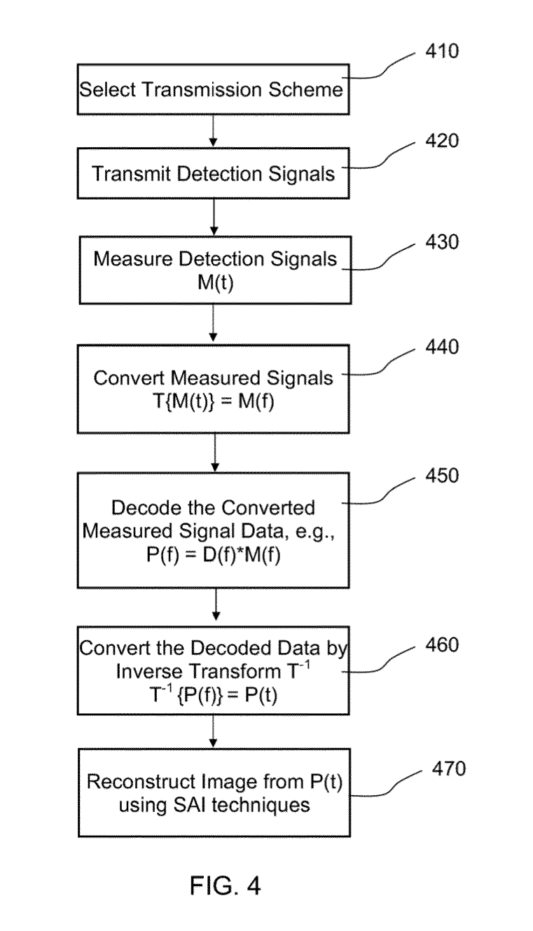

Each number 1 in this 2×2 matrix is next replaced by the 2×2 Hadamard matrix itself to extended the 2×2 Hadamard matrix to a 4×4 Hadamard matrix H₄. This process can be repeated to obtain any 2^{N}×2^{N} Hadamard matrix. The extension from a 2×2 matrix to a 4×4 matrix is illustrated below (and in FIG. 5):

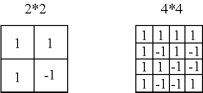 [SMILES: C1C2CC3CC4CC1C234 ; C1C2CC3CC4CC1C234]

In a final step, all elements in the 2^{N}×2^{N} Hadamard matrix that have value −1 are replaced with

$${e}^{- j 2 π f Δ t} = {e}^{- j π \frac{f}{{f}_{o}}} ,$$

where f is an arbitrary frequency in the spectrum and f₀ is an reference frequency, for example the central frequency of the signal spectrum. As will be appreciated, in time domain, this encoding scheme can be interpreted as replacing each opposite-polarized waveform in the Hadamard spatial encoding matrix with a waveform that has a half-period delay.

This special matrix H has the property that the singular values of H are all the same except for the first one and the last one. Thus,

$$D = \frac{{v}_{1} {u}_{1}^{*}}{{σ}_{1}} + \frac{{v}_{L} {u}_{L}^{*}}{{σ}_{L}} + \frac{1}{{σ}_{0}} {\sum }_{i = 2}^{L - 1} {v}_{i} {u}_{i}^{*} \qquad ( 8 )$$

which also can be written as

$$D = \frac{{v}_{1} {u}_{1}^{*}}{{σ}_{1}} ( 1 - \frac{{σ}_{1} {σ}_{1}^{*}}{{σ}_{0} {σ}_{0}^{*}} ) + \frac{{v}_{L} {u}_{L}^{*}}{{σ}_{L}} ( 1 - \frac{{σ}_{L} {σ}_{L}^{*}}{{σ}_{0} {σ}_{0}^{*}} ) + \frac{1}{{σ}_{0} {σ}_{0}^{*}} {H}^{*} \qquad ( 9 )$$

This decode matrix D can be more easily implemented in the decoder to decode signals according to Equation (3). In particular, this encoded delay and the corresponding decoding operation D enable the decoding algorithm being easily implemented in hardware. In addition, the pseudo-inverse method or other regularization techniques can be used to find a stable approximation to the decoding matrix even though the signals may be degraded by noise.

FIG. 4 illustrates an example of encoding the transmissions with different time delays at different transmitting elements. As noted earlier, in general, both the waveform and time delay may be used to encode the transmission elements. This thus allows more ways of encoding the transmission. Further, in the decoding operation, it is noted that

Pᵢₖ=Pₖᵢ (10)

in both time domain or frequency domain. This symmetry may be used in the decoding operation and to further reduce the number of required receiving elements in each transmission event while maintaining the resulted image quality. In particular, Equation (10) may be combined with Equation (1′) to decode the signal in time domain or combined with Equation (2) to decode the signal in the frequency domain.

The signal decoder may also be implemented by taking advantage of some degree of sparsity that the Pᵢₖ(f) or Pᵢₖ(t) may have in some basis such as Fourier basis, wavelet basis, waveatom basis, and curvelet basis. This sparsity can be used to solve for P by compressive sensing. An example is that a 2D Fourier transform is applied to the Pᵢₖ(f) along the transmission and receiving indexes so that sparsity might exist in the 3D spectrum. In the decoding operation, decoding process is implemented for each frequency component independently. For each frequency component, Equations (2) and (10) are combined together as a set of linear equations, which can be solved through pseudo-inverse or other regularization and compressive sensing. Compressive sensing can be used by assuming pᵢₖ(t) is sparse after some combination of transforms, such as Fourier transform, wavelet transform, waveatom transform, and curvelet transform. Some possible combination examples of these transforms are (1) a 3-D Fourier transform along i, k, and t dimensions, (2) a 2-D waveatom transform along i and t dimensions, and 1D Fourier transform along k dimension, (3) in the case of 3D imaging with a planar array (assume array plane in the x-y plane), a 5-D Fourier transform along x-direction of transmission, y-direction of transmission, x-direction of receiving, y-direction of receiving, and t dimension, 4) in the case of 3D imaging with a planar array (assume array plane in the x-y plane), a 3-D waveatom transform along x and y dimensions of the transmission index and t dimension, and 2-D waveatom transform along x and y dimensions of the receiving index. It should be pointed out that we can also combine the equations for all the frequencies together as a large set of linear equations and solve them simultaneously. Lastly, after obtaining the Pᵢₖ(f) for each frequency in the frequency spectrum of measured RF signals, an inverse Fourier transform is used to estimate pᵢₖ(t).

In general, L, the total number of transmission events for acquiring one image is not the same as the number of transmitters I. The transmission number L can be adjusted according to the need. L can be larger, equal, or smaller than I. Generally, pseudo-inversion and other regularization techniques, and other techniques such as compressive sensing can be used instead of direct matrix inversion.

Decoding can also be implemented in the time domain in some cases. In these cases, there should be no delay applied to the transmission elements and the encoding is implemented through proper choice of Cₗᵢ in Equation (1). The decoding process is implemented for each time instant independently. For each time instant, Equations (1) and (5) can be combined together as a set of linear equations, which can be solved through pseudo-inverse or other regularization and compressive sensing.

What described above in connection with FIGS. 1A and 2 to 5 relates to a special class of receiver schemes that does not combine signals at receiving elements into output channels, from which to select K₀ channels. As noted, receiver schemes are also used to combine signals measured at receiving elements into output channels. Portion of output channels may be selected and then connected to receiving electronic unit for further processing, as described above. The following provides two examples to illustrate combination of signals measured at receiving elements into output channels.

According to one example, four adjacent elements in the receiver array can be combined together as one receiver in the receiving mode. For example, the first bundle includes the first four elements. The next bundle includes the next four elements, that is, the fifth element to the eighth element, and so on. Four sets of transmission and receiving encoding protocols are used to obtain one frame of image. This will reduce the receiving channel number to K/4. In the first set, where 1≦1≦K/4, assuming n=1:K/4, the (4n−3)-th rows of a K-th order Hadamard matrix are used to encode the transmissions. Therefore, in the l-th transmission, Tₗ is the (4l−3)-th rows of a K-th order Hadamard matrix. So there are K/4 transmission events in the first set. In each transmission of the first set, the receiver encoding matrix Rₗ for the first set can be expressed as

Rₗ=I_{K/4} [symbol] V₄

where I is the identity matrix with the size of

$$\frac{K}{4} ,$$

and v₄ is a column vector of (1, 1, 1, 1), and [symbol]
represents the Kronecker product. After the application of a triangle pattern that utilizes the transmit-receive symmetry property, the receiving channel can be further reduced by half. Therefore, the final number of receiving channel is K/8. The second set of transmission and receiving encoding protocol is the same as the first set except that the (4n−1)-th rows of K-th order Hadamard matrix are used to encode the transmissions, where n=1:K/4.

The third set, where K/2+1≦l≦3K/4, and fourth set, where 3K/4+1≦l≦K, of transmission and receiving encoding protocol is similar to the first and second set except that V₄ is modified to a column vector of (1, 1, −1, −1) as V₄^{M} in the receiving-encoding scheme. Then, we have for the third and fourth set, where K/2+1≦l≦K,

Rₗ=I_{K/4} [symbol] V₄^{M}

This results in four sets of protocols that provide a complete imaging protocol in which there are K transmissions and K/8 receiving channels.

According to another example, both transmission and receiving arrays are encoded with Hadamard matrix for reducing the total number of output channels connected to the receiving electronic unit. One implementation is for the l-th transmission of the total L transmissions, the transmission encoding matrix Tₗ is just one selected row of the Hadamard matrix, and the receiver encoding matrix Rₗ can be some or all columns of a K-th order Hadamard matrix. The columns can be chosen randomly, or further optimized for a specific imaging application. The measurement signals so combined and selected can then be used to recover STA signal matrix p, or its equivalent p_{vector}, by solving Equation (3) or Equation (3″).

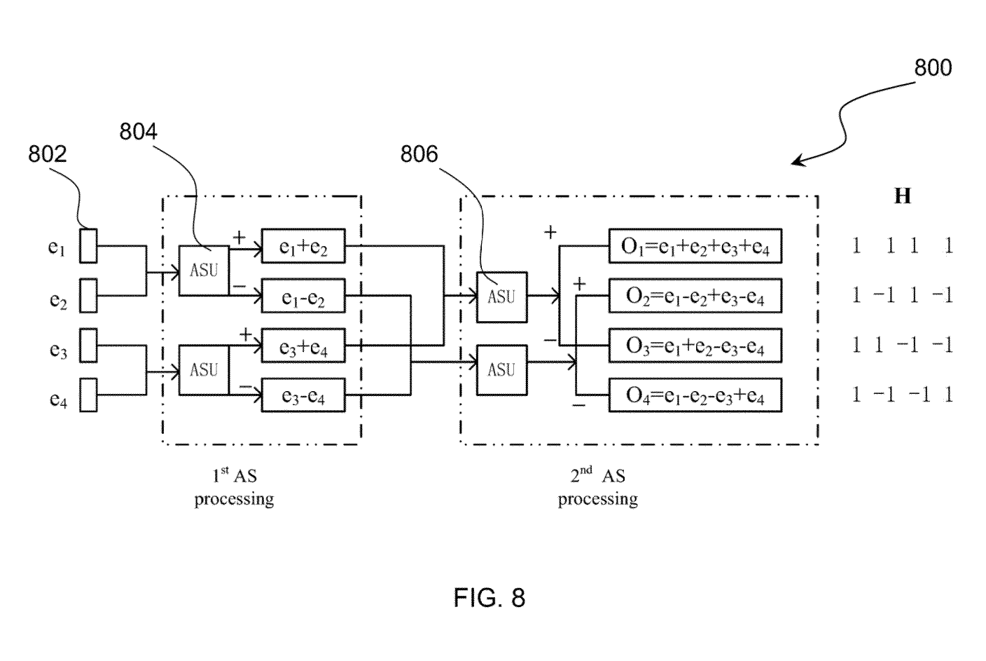

FIG. 8 shows an example of hardware implementation 800 of a MUX_R that combines and selects signals according to a set of receiver schemes. This example illustrates a MUX_R for Hadamard receiving encoding scheme for a 4-element STA, in which H is the Hadamard matrix as the receiving encoding matrix. Referring to FIG. 8, there is shown an implementation of this receiving encoding model in hardware, as is further explained below. Generally, the two adjacent elements 802 can be combined (i.e., paired) together. The information from these two elements are then passed to an additive/subtract unit (ASU) as two inputs. After processing by a first stage ASU 804, two outputs can be generated, the first output is summation of these two inputs, and the second output is the subtraction information of these two inputs. Then, all the outputs of the first group of ASUs 804 will be passed to the next group of second stage ASUs 806 as inputs for further processing. In this design, assume that there are K elements, where K=2ⁿ, this process needs to be repeated n times to encode the K receiving elements with a K-th order Hadamard matrix, to generate the encoded outputs Gₜ. In practice, to encode the K receiving elements with a K-th order Hadamard matrix, one can first encode the first group of elements 1 to K/2 with a K/2-th order Hadamard matrix to generate K/2 outputs, G₁; then one can encode the second group of elements K/2+1 to K with a K/2-th order Hadamard matrix to generate K/2 outputs, G₂. After that, the i-th output of G₁ and the i-th output of G₂ will be passed to one ASU as inputs to generate the i-th output of Gₜ which is the summation of the i-th output of G₁ and G₂, and

$$( \frac{I}{2} + i )$$

-th output of Gₜ which is the subtraction of the i-th output of G₂ from G₁.

Similar model can be applied to implementing the one-eighth receiving encoding schemes. In this case, we do not need all n levels ASU processing. After two times ASU processing, the information from the (4n−3)−th and the (4n−1)-th output channels will be used for the image reconstruction, which is equivalent to combine four elements together.

In all the above designs, when a signal in transmit or receive is needed to be reversed in polarity or coded with a negative sign, it can be implemented with a half-period delay of the signal, then decoded in the frequency domain as described in DE-STA.

Various embodiments of the invention have now been described in detail. Those skilled in the art will appreciate that numerous modifications, adaptations and variations may be made to the embodiments without departing from the scope of the invention, which is defined by the appended claims. The scope of the claims should be given the broadest interpretation consistent with the description as a whole and not to be limited to these embodiments set forth in the examples or detailed description thereof.

What is claimed is:

1. A system for generating and acquiring image data signals and processing acquired data signals for reconstructing image data, said system comprising:
a plurality of transmitting elements for emitting image detection pulse waves;
a plurality of receiving elements;
a central control processor, the central control processor controlling transmission process according to a transmission scheme and controlling receiving process according to a receiving scheme, the transmission scheme specifying transmitters of the plurality of transmitting elements that transmit during a transmission event and a waveform modification and a time delay assigned to each of the transmitting elements specified in the transmission scheme, the receiver scheme specifying receivers of the plurality of receiving elements that receive and measure signal data at each of the specified receivers,
a plurality of receiving electronics units for connection with the receiving elements to process signal data measured by the receiving elements;
a transmitter multiplexer for connecting transmitting elements specified in the transmission scheme with a signal source,
a receiver signal combiner and selector for combining specified receiving elements to form output channels and connecting the selected output channels to the receiving electronics units according to the receiver scheme;
a signal decoder, said signal decoder being coupled to the receiving electronics units and converting the measured detection signals to equivalent data as if only one transmitter transmits in each transmission event.

2. A system for generating time-delay encoded synthetic transmit aperture (“STA”) signals and processing received synthetic aperture imaging (“SAI”) signals, said system comprising:
a plurality of transmitting elements for emitting image detection pulse waves;
a plurality of receiving elements;
a controller, said controller controlling waveform and time delay assigned to each one of the plurality of transmitting elements according to a transmission scheme;
a first converter for converting time series data measured at each one of the plurality of receiving elements, said converter applying a transform to the time series data to convert the time series data to measured detection signals in a parameter domain;
a decoder, said decoder converting the measured detection signals in the parameter domain to decoded detection signals in the parameter domain by applying a decoding transformation to the measured detection signals, the decoding transformation being derived from the transmission schemes; and
a second converter for converting the decoded detection signal in the parameter domain to time domain, the second converter applying an inverse transform of the transform of the first converter.

3. The system of claim 2, further comprising:
a band filter disposed between the receiver electronics unit and the signal decoder to remove signals around selected frequencies to stabilize the decoding operation.

4. The system of claim 2, further comprising:
a band filter disposed between the first converter and the decoder to remove signals around selected frequencies to stabilize the decoding operation.

5. A method for generating synthetic transmit aperture (“STA”) signals and processing received synthetic aperture imaging (“SAI”) signals, said method comprising:
selecting a plurality of transmission schemes, each of the plurality of transmission schemes specifying a signal source to be used to activate each one of the transmitting elements in the transmission event;
transmitting at the plurality of transmitters pulse wave signals toward an image object in a plurality of transmission events, in each transmission event of the plurality of transmission events only signal sources being identified in the corresponding transmission scheme being used to activate the transmitting elements according to the transmission scheme;
receiving at a plurality of output channels the backscattered waves from the image object and measure the detected signal to obtain measured detection signals at the plurality of output channels;
converting the measured detection signals to a parameter domain by applying a transform implemented by a first signal converter;
decoding from the measured detection signals in the parameter domain equivalent detection signals at the plurality of receivers as if only one transmitting element was transmitting in each one of the transmitting event; and
converting the equivalent detection signals from the parameter domain to time domain by applying an inverse transform of the transform implemented by a first signal converter, the inverse transform being implemented by a second signal converter.

6. The method of claim 5, further comprising the step of reconstructing an image from the equivalent detection signals in the time domain by applying an SAI process.

7. A method of retrofitting a synthetic aperture imaging (“SAI”) device, said SAI imaging device having an array of transmitting elements, an array of a receiving elements, a signal source for generating a pulse signal, and an SAI unit for reconstruct an image, said method comprising:
providing a time delay array disposed between the signal source and the array of transmitting elements, said time delay array having delay elements for introducing individually controllable time delays to signals sent from the signal source to each transmitting elements,
providing a controller, said controller controls the individually controllable time delays specified in a transmission scheme, said transmission scheme specifies one or more transmitting elements of the array of transmitting elements to transmit pulse signals in a transmission event and a time delay associated with each of the pulse signal transmitted in the transmission event,
providing a first converter, said first converter being constructed to implement a transform for converting time series detection signals measured at the array of receivers to a parameter domain by applying the transform,
providing a decoder, said decoder being constructed to decode from the measured detection signals in the parameter domain equivalent detection signals at the array of receivers as if only one transmitting element was transmitting in each one of the transmitting event, and
providing a second converter, said second converter being constructed to implement an inverse transform for converting the equivalent detection signals from the parameter domain to the time domain to estimate a set of equivalent SAI data signals, said set of equivalent SAI data signals being provided to the SAI unit for reconstruct the image.
